(19) United States
(12) Patent Application Publication
(10) Pub. No.: US 2010/0174825 A1
(43) Pub. Date: Jul. 8, 2010

(54) INTERNET RADIO SYSTEMS AND METHODS THEREOF

(76) Inventors: Michelle Wu, Shanghai (CN); Graham Golder, Fremont, CA (US); Yaheng (Edward) Yu, Shanghai (CN); Geng Li, Shanghai (CN)

Correspondence Address: IPSG, P.C., P.O. BOX 700640, SAN JOSE, CA, 95170, US

(21) Appl. No.: 12/349,467

(22) Filed: Jan. 6, 2009

(51) Int. Cl. G06F 15/16

(52) U.S. Cl. 709/231

(57) ABSTRACT

An Internet radio infrastructure comprising at least a media server and one or more wireless portable internet radio devices and/or one or more media center devices is proposed. The internet radio infrastructure is configured for broadcasting, archiving, and playing internet radio streams in a manner that would not only provide increased flexibility and options for the users as well as simplified management for the internet radio infrastructure implementer, but would also save time and resources in the implementation and maintenance of an internet radio system.

### BACKGROUND OF THE INVENTION

Internet radio is an audio broadcasting service transmitted over the Internet that has long been employed by users for broadcasting, receiving, and playing internet radio streams. Although there exist many different protocols for transmitting audio broadcasts over the Internet, common characteristics of internet radio include the ability to perform one-to-one as well as one-to-many transmission using internet technologies as well as the ability to exert control over which user can receive the internet radio data. As such internet radio is distinguishable from analog radio broadcasts (such as FM or AM broadcasts) that have been in use many decades prior.

As internet radio continues to evolve, many corporations, individuals, and organizations utilize internet radio for advertising, news publications, seminars, listening to music or sports programs, etc. For example, individuals may utilize internet radio to receive and play their favorite music streams, or corporations may utilize internet radio to broadcast training seminars to their employees around the globe.

Traditionally, in order to broadcast an internet radio stream to an audience, a microphone or audio recording device maybe utilized to record audio to a laptop or desktop computer. Once the audio has been recorded, an encoder program in the laptop or desktop computer then converts the audio file into a streaming format. Once the audio file has been converted to a streaming format, the audio stream would then be sent to a broadcasting server via the Internet. The broadcasting server would then transmit the audio stream over the Internet to enable subscribing listeners, who can then receive and play the audio stream via their computer's player.

Consider the situation wherein, for example, manager A of Corporation ABC wants to broadcast a training seminar to Corporation ABC's employees through his corporate private internet radio station. Manager A is currently driving for three hours to a meeting and wants to utilize this time to conduct the training seminar. Manager A, having no laptops or computers available during his drive, would first record the training seminar audio on to a handheld digital voice recorder, for example.

Once manager A has arrived at his destination, manager A would then connect his handheld digital voice recorder to his laptop and upload the recorded training seminar to the laptop. Once the recorded training seminar has been uploaded to the laptop, an encoder in the laptop then converts the audio file into a streaming format in order for the audio to be able to be sent via the Internet to a broadcasting server. Once the audio stream has been received by the broadcasting server, the broadcasting server transmits the audio stream over the Internet to enable the subscribing employees of Corporation ABC to receive and play the training seminar via their computer's player.

Although the above-discussed traditional internet radio stream broadcasting approach may accomplish the task of broadcasting internet radio streams, such implementation may be inconvenient in some situations. For example, organizations and/or individuals may need to have internet radio broadcasting capabilities when not at their laptop or desktop computer. Further, laptops and desktops are costly since they are general purpose devices and tend to have additional circuitries and software that are not absolutely necessary for manipulating/playing internet radio. Additionally, desktop and laptop computers are complicated devices having operating systems, application software, virus vulnerabilities, and other issues which complicate implementation and maintenance if internet radio is the only application of interest.

Accordingly, improvements and innovations are continually made in the field of internet radio. This disclosure relates to such improvements and innovations.

### SUMMARY OF THE INVENTION

The invention relates, in an embodiment, to an internet radio system implemented over the internet. The internet radio system includes a media server having at least user access data storage, file storage, and a first network interface for communicating with the internet. The internet radio system further includes a wireless portable internet radio device having at least a display screen, a first user input device, and a second network interface for communicating with the media server via the internet. The wireless portable internet radio device further includes a first audio transducer for recording a first audio input and a first encoder/decoder for converting the first audio input into a first audio file for streaming to the media server, wherein the streaming occurs contemporaneously with the first audio input being recorded by the first audio transducer.

In one or more embodiments, the internet radio system further includes a media center configured for coupling with a stationary output device. The media center includes at least a second user input device, a third network interface for communicating with the media server via the internet, and a second encoder/decoder for converting a second audio input received at the media center into a second audio file for streaming to the media server, wherein the streaming occurs contemporaneously with the second audio input being received by the media center.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with an embodiment of the present invention, an example of the internet radio system architecture.

FIG. 2 shows, in accordance with an embodiment of the present invention, the major functional blocks of the wireless portable internet radio device.

FIG. 3 shows, in accordance with an embodiment of the present invention, the major functional blocks of the media center.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In one or more embodiments of the invention, an Internet radio infrastructure comprising at least a media server and one or more wireless portable internet radio devices and/or one or more media center devices is proposed. The internet radio infrastructure is configured for broadcasting, archiving, and playing internet radio streams in a manner that would not only provide increased flexibility and options for the users as well as simplified management for the internet radio infrastructure implementer, but would also save time and resources in the implementation and maintenance of an internet radio system.

Accordingly, one or more embodiments of the invention relate to a wireless portable internet radio device for receiving through the Internet one or more internet radio streams from a media server and/or a third party internet radio broadcast server and for playing the internet radio streams. In one or more embodiments, the wireless portable internet radio device is also configured to record an audio input via a microphone built into the wireless portable internet radio device and for streaming the data stream encoded from the audio input or sending a complete audio file to a media server and/or a third party internet radio broadcast server for broadcasting. In this document, streaming refers to the transmission of the audio file before recording is completed while sending the audio file refers to the transmission of the entire audio file after recording has been completed.

In one or more embodiments of the invention, the wireless portable internet radio device may include a user input device, a display screen, a network interface circuit, one or more speakers, one or more microphones, memory, and an audio/video decoder and encoder. The network interface is configured for connecting to the Internet in order to access a media server or third party broadcasting server for uploading, broadcasting, and/or receiving internet radio streams.

In one or more embodiments of the invention, a microphone built into the wireless portable internet radio device may be employed to record an audio input. Once the audio input has been recorded, the recorded audio input may then be stored in a storage device (e.g., a hard drive or flash memory) and/or encoded by the audio/video encoder into a streaming format, in an embodiment. The encoded audio stream then is streamed or sent by the network interface to one or both of a media server or third party broadcasting server.

In one or more embodiments of the invention, a recording of a portion or all of an internet radio stream may be made from the internet radio stream received at the wireless portable internet radio device. The user may input an appropriate command to instruct the portable wireless internet radio device to record a specified portion or all of an internet radio stream currently received or scheduled to be received by the wireless portable internet radio device. The recorded audio file may be stored onboard the portable wireless internet radio device for later use or streamed or sent to the media server for archiving and/or re-broadcasting, for example.

In accordance with an embodiment of the invention, there exists an idle-play mode wherein the wireless portable internet radio device is configured to receive and play one or more internet radio streams while the wireless portable internet radio device is in an idle state.

One or more embodiments of the invention also relate to a method, using a wireless portable internet radio device, for streaming internet radio to a media server for broadcast or archive and for receiving internet radio streams from a media server or from a third party internet radio server for replay. In one or more embodiments, the invention relates to a method for recording audio input using the handheld radio device. The recorded audio information may be encoded by an onboard encoder in the wireless portable internet radio device. The encoded audio information may optionally be stored in onboard storage in the wireless portable internet radio device for example where there is no immediate internet access. The encoded audio information may be streamed as an internet radio stream substantially simultaneously as the recording occurs to a media server for broadcasting or archiving or to a third party internet radio broadcast server for broadcasting.

One or more embodiments of the invention also relate to a media server configured for working cooperatively with the wireless portable internet radio devices. The media sever includes a file storage facility configured for storing audio files received from the wireless portable internet radio devices or from third party internet radio broadcast servers. The media server further includes command handler software for executing commands issued by the wireless portable internet radio devices. The media server also includes a user database for controlling subscription and access by the wireless portable internet radio devices to the media server.

Embodiments of the invention also relate to a media center device configured to be coupled to a stationary output device, such as a display screen or external speakers, for receiving through the Internet one or more internet radio streams from one of a media server and a third party internet radio broadcast server and for playing one or more internet radio streams on the stationary output device.

In one or more embodiments, the media center device is also configured to schedule a recording of one or more internet radio streams and store the internet radio stream as an audio file into local storage (e.g., a hard drive or flash memory) for later replay by the user. In one or more embodiments, the media center device is also configured to record an audio input via a built-in microphone or an external microphone or a microphone that is coupled to a remote control device and for streaming the data stream encoded from the audio input to a media server for broadcasting or archiving or a third party internet radio broadcast server for broadcasting.

In one or more embodiments of the invention, the media center device may include a network interface, a storage device, a media center remote control, microphone, and an audio/video decoder and encoder. The network interface is configured for connecting to the Internet in order to access a media server or third party server for transmitting commands, for uploading, broadcasting, and/or receiving internet radio streams. In accordance with an embodiment of the invention, there exists an idle-play mode wherein the media center device is configured to receive and play one or more internet radio streams while the media center device is in an idle state.

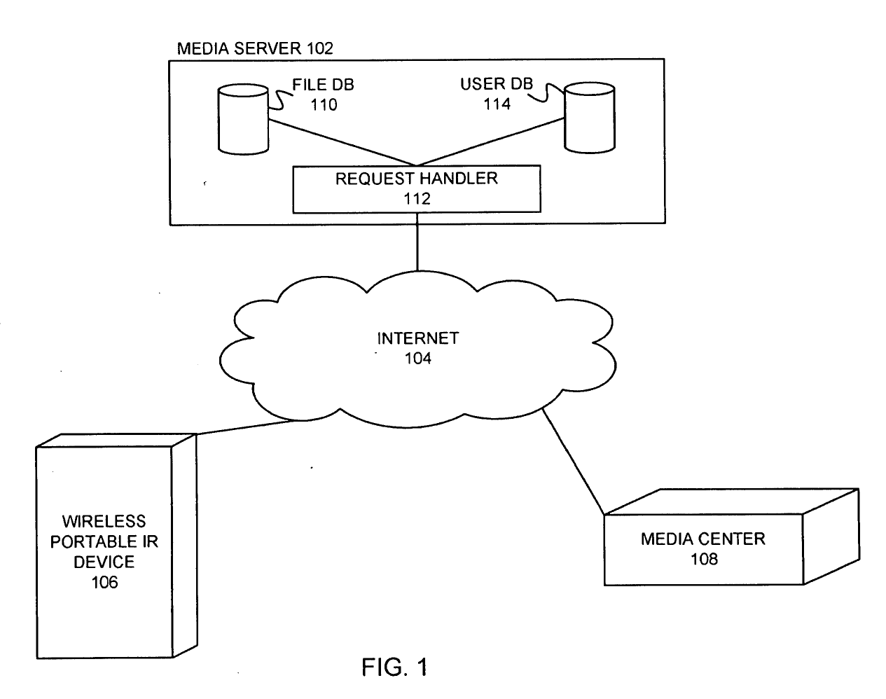

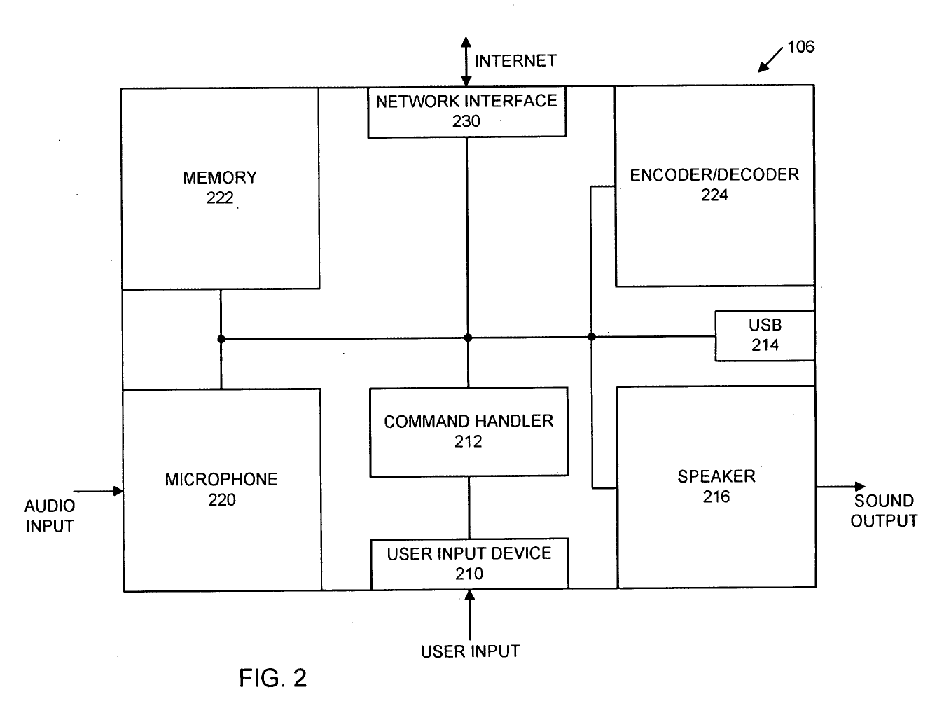

The features and advantages of the invention may be better understood with reference to the figures and discussions that follow. FIG. 1 shows, in accordance with an embodiment of the present invention, an example of the internet radio system architecture. In FIG. 1, there are shown media server 102, internet 104, wireless portable internet radio device 106, and media center device 108. Media server 102 includes a file storage 110 representing for example a hard disk drive or another suitable high capacity storage devices. Wireless portable internet radio device 106 represents the portable device employed to receive internet radio streams from one or both of media server 102 and a third party internet radio broadcast server (not shown) for replay as well as to issue commands and to record/stream audio input in an internet radio format to media server 102. Wireless portable internet radio device 106 will be discussed later herein in connection with FIG. 2.

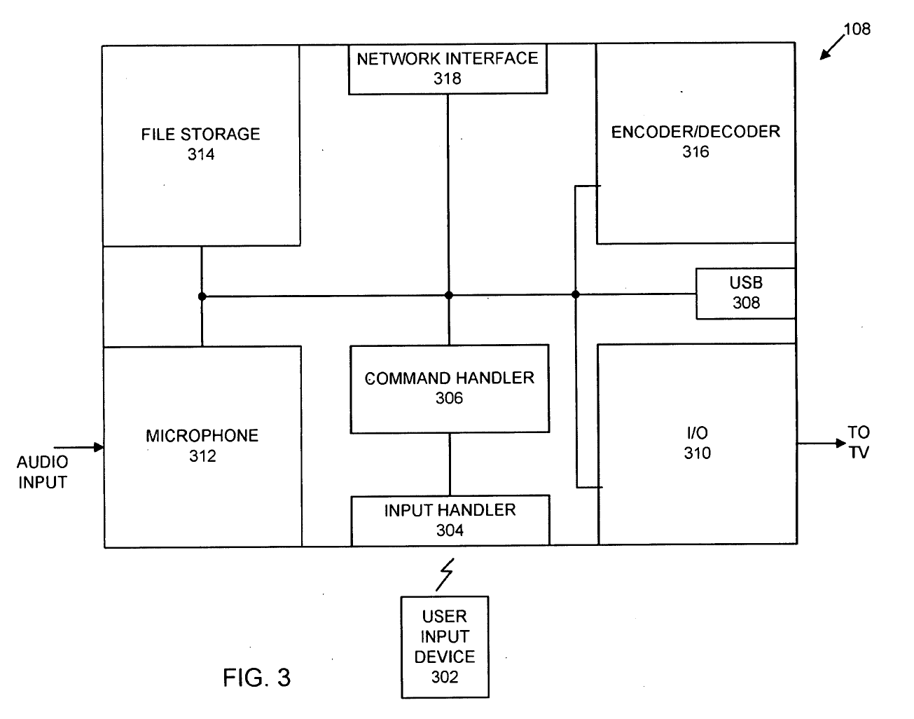

Media center device 108 represents a non-portable (such as a set-top box) device that is connected to a stationary output device (such as a stationary display or speakers). Media center device 108 is configured to receive internet radio streams from one or both of media server 102 and a third party internet radio broadcast server (not shown) for replay on the stationary output device as well as to issue commands and to record/stream audio input in an internet radio format to media server 102. Functionally speaking, media center device 108, being not as portable and thus not as constrained with respect to form factor and battery power compared to wireless portable internet radio device 106, may perform all functions of wireless portable internet radio device 106 but may also be endowed with faster processor(s), larger storage, and even a remote control unit for user convenience. Media center device 108 will be discussed later herein in connection with FIG. 3.

The internet radio system architecture of FIG. 1 also includes request handler 112, and user database 114. Request handler 112 represents the software employed to receive and interpret commands from one or both of wireless portable internet radio device 106 and media center device 108. User database 114 is configured to include user account information and preferences, and is employed, in an embodiment, to control subscription access to the internet radio service as well as to specific internet radio data streams.

In one or embodiments, a cradle may be provided. The cradle may provide a platform for charging the wireless portable internet radio device when the portable wireless internet radio device is plugged into or is placed into the cradle. Further, the cradle may also have connectivity to the internet such that when the wireless portable internet radio device is disposed in the cradle, connectivity may be made through the cradle instead of or in addition to the internet connectivity provided by the onboard wireless interface. Furthermore, the cradle may be provided with plugs or connection to permit peripheral devices to be in electrical or data communication with the wireless portable internet radio device. By way of example, a set of external speakers may be plugged into the cradle to allow the wireless portable internet radio device to play audio via the external speakers when the wireless portable internet radio device is disposed in the cradle.

A few example use scenarios will now be discussed. Suppose a user wishes to interact with media server 102 for example to log in or to issue a command to retrieve internet radio data. With reference to FIG. 1, the user would initiate a user input request through an appropriate user input device (such as a touch screen) of wireless portable internet radio device 106 or through a remote control device that is associated with media center 108.

Once the user has input the user request, a command handler on board either the wireless portable internet radio device 106 or media center 108 would then process the request onboard and/or forward the request to an onboard network interface if the request pertains to media server 102. The network interface would then access, via internet 104, media server 102 to forward the command to media server, where the command will be parsed and handled by request handler 112.

In the case of logging in, the user's credential accompanying the log-in command would be compared against user data in user database 114 and access (as well as service level determination, if applicable) would be determined based on the comparison. In the case of internet radio stream retrieval, media server 102 may retrieve stored internet radio files from its internal storage 110 or from a third party internet radio server and stream the requested data to respective wireless portable internet radio device 106 or media center 108, for example.

As another example use scenario, if a user wishes to search for a particular internet radio program, the user may input his request through the touch screen of wireless portable internet radio device 106 or via a remote control of media center 108. Once the user has input his user request, a command handler on board either the wireless portable internet radio device 106 or media center 108 would then process the request onboard and/or forward the request to an onboard network interface if the request pertains to media server 102.

For example, if the internet radio programming data has been cached in the onboard memory of wireless portable internet radio device 106 or media center 108, the requested internet radio programming data may be provided (on the built-in display screen or an external display screen, for example) to the user from data cached in wireless portable internet radio device 106 or media center 108. More typically, the network interface circuit of wireless portable internet radio device 106 or media center 108 would then access media server 102 via the internet 104 to forward the command to media server 102, where the command will be parsed and handled by request handler 112.

In some cases, media server 102 may query third party internet radio programming guides (available commercially from sources such as radiotimes.com) and retrieve the requested internet radio programming data to forward back to respective wireless portable internet radio device 106 or to media center 108 (via the internet and appropriate network interfaces). By way of example, one or more URLs may also be returned to wireless portable internet radio device 106 or to media center 108, enabling wireless portable internet radio device 106 or to media center 108 to directly receive the streamed internet radio data from third party internet radio servers upon selection by the user.

As another example use scenario, if a user wishes to record and stream an internet radio file from one of wireless portable internet radio device 106 or media center 108 to media server 102 for broadcasting or archiving, the user may initiate the recording action via the touch screen of wireless portable internet radio device 106 or via the remote control of media center 108. The command inputted by the user turns on the microphone to receive the audio input. An onboard encoder encodes the audio input into an appropriate internet radio format for streaming to media server 102.

Depending on the specific instruction inputted by the user, the streamed audio data to media server 102 may be accompanied by an appropriate instruction from the logic circuitry and network interface of wireless portable internet radio device 106 or media center 108 to instruct media server 102 to store the internet radio stream or to broadcast the internet radio stream. The instruction may be received via the network interface of media server 102 and handled by request handler 112 of media server 102. In the archiving case, for example, media server 102 may store the received internet radio stream in file storage 110 and associate the stored file with the user for later retrieval. In the broadcast case, for example, media server 102 may immediately or at a specified time later broadcast the received internet radio stream for reception by users who subscribe to receive such internet radio data.

Note that while internet radio streaming of recorded-and-encoded audio data occurs, new audio input of the same recording session may be recorded and encoded. As soon as an audio input is recorded, it is encoded and transmitted in a streaming fashion. Thus, the need to store a large amount of audio data in the wireless portable internet radio device 106 or in media center 108 is made unnecessary since the audio data is streamed instead of stored locally. Further, delay is eliminated since internet radio data is streamed even while recording is taking place. As such, the limited storage/battery life of wireless portable internet radio device 106 does not present an impediment to the recording (and broadcasting, if desired) of audio data, irrespective of the volume of data involved. If desired, the caching of the streamed internet radio stream in wireless portable internet radio device 106 or media center 108 may be implemented but such is not a necessity to accomplish the archiving or broadcasting of the recorded audio data.

FIG. 2 shows, in accordance with an embodiment of the present invention, the major functional blocks of the wireless portable internet radio device 106 of FIG. 1. In FIG. 2, there is shown a touch screen 210, representing the user input device employed for receiving user input. However, in some implementations, other user input devices such as touch pad, key pad, key boards, dedicated buttons, etc., may also be implemented alternatively or additionally. Command handler 212 receives commands inputted via touch screen 210 or via USB port 214 (discussed later herein) and includes logic circuitry to execute the commands.

Speaker 216 represents the audio transducer employed to output sound. In some cases, an output jack may be provided additionally or alternatively in order to facilitate the production of sound via a plug-in peripheral device (such as headphones). USB circuit 214 represents an I/O interface for inputting/outputting data with respect to wireless portable internet radio device 106. As an example, audio files may be transmitted to wireless portable internet radio device 106 from another device via USB interface 214 for archiving/broadcasting. As another example, audio files may be outputted from wireless portable internet radio device 106 to another device via the USB interface 214. As yet another example, the USB interface may be employed to interact with other peripheral devices, such as external headphones, external microphones, external wireless transmitters, other entertainment devices, etc. In an example, commands may be received via USB port 214 instead of or in addition to the commands received via touch screen 210.

Microphone 220 represents the audio transducer employed to record audio from the ambient environment (such as the user's voice, for example). The recorded audio files may be temporarily stored onboard in storage 222 (for example flash memory) and/or sent to encoder/decoder 224 for encoding prior to being streamed to media server 102 for archiving/broadcasting. Network interface 230 represents the circuitry for communicating, via the internet, with media server 102 and/or third-party internet radio servers (to receive internet radio streams directly therefrom). Network interface 230 may be implemented by any suitable wireless transmission technology, including wireless technologies based on the IEEE 802.11 standard family or based on a cellular telephone protocol, for example.

In one or more embodiments, the media center facilitate applications such as gaming, chat, emails, that involve voice, image, and video. Thus, the media center acts as a platform for deploying applications, both resident and under subscription that involve the aforementioned voice, image, and/or video.

A few example use scenarios will now be discussed to further elaborate on the functions of the various functional blocks shown in FIG. 2. As an example use scenario, suppose a user wishes to record and immediately broadcast audio via his wireless portable internet radio device. The user first inputs the appropriate command via the user input device, such as touch screen 210. The command received is parsed and handled by command handler 212, which instructs microphone 220 to turn on to record the audio input.

After audio input is recorded and encoded into an internet radio stream by encoder/decoder 224 (with optional caching using storage 222 if desired), the internet radio stream is uploaded to media server 102 via network interface 230 and internet 104 (see FIG. 1). At media server 102, the commands that accompany the uploaded internet radio stream are parsed and handled by request handler 112 of media server 102. For example, such command may instruct media server 102 to re-broadcast to users that have subscribed to the internet radio stream (the subscription information may be stored in user database 114, for example). The re-broadcast may be preformed based on a push paradigm wherein the audio information will be pushed to subscribing users for real-time or later consumption. Such command may also optionally instruct media server 102 to store the media stream into file storage 110 for later retrieval, if desired.

As another example use scenario, suppose the user wishes to receive, as an internet radio stream, an audio file previously stored with media server 102. In this case, the user would enter the appropriate command via the user input device (such as touch screen 210). The command received is parsed and handled by command handler 212, which results in the formulation of commands for media server 102. Such commands would then be transmitted to media server 102 via network interface 230 and internet 104. At media server 102, the command is parsed and handled by request handler 112 of media server 102. For example, such command may instruct media server 102 to access a particular audio file in file storage 110 and to stream such audio file as an internet radio stream to the user's wireless portable internet radio device for replay. When the internet radio stream is received at network interface 230 of portable internet radio device 106, the internet radio stream is decoded via encoder/decoder 224 into an audio stream to be played via speaker 216.

As another example use scenario, suppose the user wishes to receive, as an internet radio stream, an audio file from a third party internet radio server. In this case, the user would enter the appropriate command via the user input device (such as touch screen 210). The command received is parsed and handled by command handler 212, which results in the formulation of commands for media server 102. Such commands would then be transmitted to media server 102 via network interface 230 and internet 104.

At media server 102, the command is parsed and handled by request handler 112 of media server 102. For example, such command may instruct media server 102 to access a third party internet radio server and to stream such audio file as an internet radio stream to the user's wireless portable internet radio device for replay/download. Alternatively, media server 102 may instruct the third party internet radio server to directly stream the internet radio stream to the wireless portable internet radio device for replay/download. When the internet radio stream is received at network interface 230 of portable internet radio device 106, the internet radio stream is decoded via encoder/decoder 224 into an audio stream to be played via speaker 216.

As another example use scenario, the user may enter preference setting data into wireless portable internet radio device 106 to specify that when wireless portable internet radio device 106 enters the idle mode (e.g., after a specified period of inactivity), a particular internet radio stream is automatically received from a third party internet radio server or from media server 102 and replayed through the device's speaker. In this case, the command to retrieve the internet radio stream is issued by logic circuits in the wireless portable internet radio device upon entering the idle mode, and the radio stream may be obtained for replay in the manner discussed in connection with the earlier examples.

As another example use scenario, suppose the user wishes to browse internet radio programming data to decide which internet radio stream to receive. In this case, the user would enter the appropriate command via the user input device (such as touch screen 210). The command received is parsed and handled by command handler 212, which results in the formulation of commands for media server 102. Such commands would then be transmitted to media server 102 via network interface 230 and internet 104. At media server 102, the command is parsed and handled by request handler 112 of media server 102. For example, such command may instruct media server 102 to access a third party internet radio programming data server (such as radiotimes.com) and obtain internet radio programming data for the user's review. Internet radio programming data may be returned to the wireless portable internet radio device, either directly from the third party internet radio programming device or via media server 102. By selecting the hyperlink associated with the returned internet radio programming data, the user may select the appropriate internet radio stream for replay or download.

FIG. 3 shows, in accordance with an embodiment of the present invention, the major functional blocks of media center 108. Generally speaking, media center 108 has similar functional blocks and capabilities as portable internet radio device 106 but without the form factor/battery life restrictions of a portable battery-powered device. As such, a larger storage facility (such as one or more hard drives) may be provided onboard, along with more powerful processors, higher speed I/O circuitry, more random access memory, etc. Additionally, since portability is not a requirement, media center 108 may communicate with the internet using an optical, wired, or wireless transmission technology. The use of non-wireless technologies may offer a higher transmission speed, based on currently available technologies.

In an embodiment, media center 108 is implemented as a set-top box to be connected to a stationary display, such as a television or an external display screen. As such, media center 108 typically outputs its audio output to the speaker associated with the stationary display for playback. A microphone can be integrated with media center 108 or an integrated jack may be provided to allow a plug-in microphone to be employed or a USB microphone may be employed.

User input may be performed via a built-in user input device (such as touch screen panel, key pad, key board, or dedicated keys for example) or via a remote control device that communicates with the set-top box via a suitable wireless technology such as infrared. The remote control itself may receive the user inputs via a touch screen, a key pad, a key board, and/or dedicated keys, for example. The remote control may include air mouse, trackballs, keyboards, keypads, dedicated keys, and any other user input technology as appropriate such as trackpad, etc.

With reference to FIG. 3, there is shown an input device 302, representing the user input device employed for receiving user input. In the example of FIG. 3, input device 302 is a keyboard/mouse combination. However, in some implementations, other user input devices including for example a wireless remote control device may also be implemented alternatively or additionally. Input handler 304 serves to receive the commands inputted from the user device, formats and passes the commands onto a command handler 306 for executing the commands. Command handler 306 receives commands inputted via input device 302 or via USB port 308 (discussed later herein) and includes logic circuitry to execute the commands.

I/O 310 represents the I/O port for coupling with a stationary output device such as a television set or an external audio output device (such as speakers) for generating the audio and/or video output. USB circuit 308 represents an I/O interface for inputting/outputting data with media center 108. As an example, audio files may be transmitted to media center 108 from another device via USB interface 308 for archiving/broadcasting. As another example, audio files may be outputted from media center 108 to another device via the USB interface. As yet another example, USB interface 308 may be employed to interact with other peripheral devices, such as external headphones, external microphones, external wireless transmitters, other entertainment devices, etc. In an example, user commands may be received via USB port 308 instead of or in addition to the commands received via input device 310.

Microphone 312 represents the audio transducer employed to record audio. Although microphone 312 is shown integrated with media center 108 in the example of FIG. 3, microphone 312 may be provided as a separate peripheral or may be integrated with the user input device 302 (e.g., keyboard or remote control). The recorded files may be temporarily stored onboard in storage 314 (for example one or more hard drives) and/or sent to encoder/decoder 316 for encoding prior to being streamed to media server 102 for archiving/broadcasting. Network interface 318 represents the circuitry for communicating, via the internet, with media server 102 and/or third-party internet radio servers (to receive internet radio streams directly therefrom).

As can be appreciated from the foregoing, embodiments of the invention facilitate the implementation of an efficient and simple to manage internet radio system. With embodiments of the invention, recording of audio input and streamed internet radio, as well as broadcasting, is possible from a portable wireless device itself. Embodiments of the invention permit broadcasting, receiving, and playing internet radio streams without undue delay and in a user-friendly, intuitive manner. By seamlessly streaming internet radio data to/from the media server and employing the media server to handle more intensive database and storage functionalities, embodiments of the invention overcome the physical and/or battery life constraints associated with wireless portable internet radio devices.

While this invention has been described in terms of several preferred embodiments, there are alterations, permutations, and equivalents, which fall within the scope of this invention. Although various examples are provided herein, it is intended that these examples be illustrative and not limiting with respect to the invention. Instead, the discussions are meant as examples and the invention is not limited by the examples presented. For example, in this document, various implementations may be discussed using audio stream as examples. This invention, however, is not limited to audio streams and may include any data streams that may be broadcasted, received, and played on an internet radio device. As another example, although only one wireless portable internet radio device and one media center are shown in the example, each media server may serve any number of wireless portable internet radio devices and media centers.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. An internet radio system implemented over the internet, comprising:
a media server having at least
user access data storage,
file storage, and
a first network interface for communicating with said internet; and
a wireless portable internet radio device having at least
a display screen,
a first user input device,
a second network interface for communicating with the media server via said internet,
a first audio transducer for recording a first audio input, and
a first encoder/decoder for converting said first audio input into a first audio file for streaming to said media server, wherein said streaming occurs contemporaneously with said first audio input being recorded by said first audio transducer.

2. The internet radio system of claim 1 wherein said wireless portable internet radio device further comprises:
a second audio transducer for converting a streamed internet radio stream received at said wireless portable internet radio device into audio output.

3. The internet radio system of claim 1 wherein said second network interface communicates with said internet using a protocol in the IEEE 802.11 family of protocols.

4. The internet radio system of claim 1 wherein said user access data storage is configured for storing user access credentials.

5. The internet radio system of claim 1 wherein said media server further includes a command handler for executing commands sent by said wireless portable internet radio device.

6. The internet radio system of claim 5 wherein said commands sent by said wireless portable internet radio device includes a command to obtain internet radio programming data from a third party internet radio programming data server on behalf of said wireless portable internet radio device.

7. The internet radio system of claim 1 wherein said user input device represents a touch screen input device.

8. The internet radio system of claim 1 further comprising:
a media center configured for coupling with a stationary output device, said media center having at least
a second user input device,
a third network interface for communicating with the media server via said internet,
a second encoder/decoder for converting a second audio input received at said media center into a second audio file for streaming to said media server, wherein said streaming occurs contemporaneously with said second audio input being received by said media center.

9. The internet radio system of claim 8 wherein said second user input device represents a detachable keyboard.

10. The internet radio system of claim 8 wherein said media center represents a set-top box.

11. The internet radio system of claim 10 wherein said stationary output device represents an external display device.

12. The internet radio system of claim 11 wherein said stationary output device represents a television set.

13. The internet radio system of claim 11 wherein said stationary output device represents a set of external speakers.

14. The internet radio system of claim 13 wherein said second user input device represents a remote control device.

15. The internet radio system of claim 8 wherein said media center further includes a third audio transducer configured to record said second audio input, said third audio transducer being integrated into said remote control device.

16. An internet radio system implemented over the internet, comprising:
a media server having at least
file storage,
a first network interface for communicating with said internet; and
a wireless portable internet radio device having at least
a display screen,
a first user input device,
a wireless network interface for communicating with the media server via said internet, and
first means for recording and streaming a first internet radio file to said media server, said streaming in said wireless portable internet radio device being performed contemporaneously with said recording in said wireless portable internet radio device, wherein said media server further includes means for executing commands received from said wireless portable internet radio device.

17. The internet radio system of claim 16 further comprising:
a media center configured for coupling with a stationary output device, said media center having at least
a second user input device,
a third network interface for communicating with the media server via said internet, and
second means for recording and streaming a second internet radio file to said media server, said streaming by said media center being performed contemporaneously with said recording by said media center.

18. The internet radio system of claim 16 wherein said stationary output device represents a television set.

19. The internet radio system of claim 16 wherein said second user input device represents a remote control device.

20. The internet radio system of claim 17 wherein said second means includes a third audio transducer configured to record a second audio input, said third audio transducer being integrated into said remote control device.
